(19) United States
(12) Patent Application Publication
(10) Pub. No.: US 2023/0197336 A1
(43) Pub. Date: Jun. 22, 2023

(54) SINGLE CORE CROSS-COUPLED MULTI-PHASE INDUCTOR

(71) Applicant: Our Next Energy, Inc., Novi, MI (US)

(72) Inventor: Aaron C. Harkness, Howell, MI (US)

(21) Appl. No.: 18/085,153

(22) Filed: Dec. 20, 2022

Related U.S. Application Data
(60) Provisional application No. 63/265,832, filed on Dec. 21, 2021.

(51) Int. Cl. H01F 38/02; H01F 27/24; H01F 27/30; H02M 3/158; H02M 1/00; H02M 1/14

(52) U.S. Cl. CPC H01F 38/023; H01F 27/24; H01F 27/306; H02M 3/158; H02M 1/0064; H02M 1/14; H01F 2038/026

(57) ABSTRACT

A cross-coupled multi-phase inductor that includes a single core and pairs of adjacent windings wound on the single core. Each member of an adjacent pair includes a first sub-winding and a second sub-winding which extends from the first sub-winding and each member is cross-coupled with the other member of the pair such that the first and second sub-windings of each member of the adjacent pair are disposed diametrically opposite or substantially diametrically opposite each other on the single core. This results in reducing core losses and increasing power conversion efficiency of the cross coupled multi-phase inductor.

### TECHNICAL FIELD

The disclosure relates generally to power converters and more specifically, to single core multi-phase inductors with cross-coupling.

### BACKGROUND

Power distribution systems may be found in electric vehicles and may be used to power a number of vehicle components and accessories. Vehicle control modules, such as a powertrain controller, body controller, battery controller, and the like, as well as vehicle lighting, HVAC, windows, mirrors, wipers, infotainment system, navigation system, and countless other systems, motors, actuators, sensors, modules, and the like, may be powered by power distribution systems having low voltages such as by 12V or 24V or 48V power distribution systems.

### BRIEF SUMMARY

In one aspect, a cross-coupled multi-phase inductor is disclosed. The cross-coupled multi-phase inductor may include a single core, and at least one pair of adjacent windings wound on the single core. The at least one pair of adjacent windings may comprise a main winding and a coupled winding and each adjacent winding of the at least one pair of adjacent windings may further comprise a first sub-winding on the core and a second sub-winding on another part of the core, the second sub-winding extending from the first sub-winding. The first and second sub-windings of the main winding may be disposed on first opposing sides of the single core. The opposing sides may be diametrically opposite or substantially diametrically opposite each other as described hereinafter. The first and second sub-windings of the coupled winding may also be disposed on second opposing sides of the single core and the first and second sub-windings of the main winding may be cross-coupled with the first and second sub-windings of the coupled winding.

The first and second sub-windings of the at least one adjacent winding may be wound to produce corresponding fluxes in the single core in a same direction. Each adjacent winding may form an inductor, and the cross-coupled multi-phase inductor may have an even number of inductors. Other technical features may be readily apparent to one skilled in the art from the following figures, descriptions, and claims.

In another aspect, a power converter may be disclosed. The power converter may include a plurality of inductors configured as a cross-coupled multi-phase inductor. Further, the power converter may be a buck converter. Other technical features may be readily apparent to one skilled in the art from the following figures, descriptions, and claims.

In yet another aspect, a method of producing and/or using a cross-coupled multi-phase inductor is disclosed. The method may include providing a single core, and winding, on the single core, at least one pair of adjacent windings, the at least one pair of adjacent windings including a main winding and a coupled winding and each adjacent winding of the at least one pair of adjacent windings further including a first sub-winding and a second sub-winding which extends from the first sub-winding. The method may also include cross-coupling the adjacent windings by disposing the first and second sub-windings of the main winding on first opposing sides of the single core and disposing the first and second sub-windings of the coupled winding on second opposing sides of the single core, said second opposing sides being adjacent to said first opposing sides and each side of a pair of opposing sides being diametrically opposite or substantially diametrically opposite each other on the single core. Other technical features may be readily apparent to one skilled in the art from the following figures, descriptions, and claims.

### BRIEF DESCRIPTION OF THE DRAWINGS

To easily identify the discussion of any particular element or act, the most significant digit or digits in a reference number refer to the figure number in which that element is first introduced.

FIG. 1 depicts a block diagram of a drivetrain and power supply components in accordance with illustrative embodiments.

FIG. 2 depicts a block diagram of a power supply system in which illustrative embodiments may be implemented.

FIG. 3A depicts a two-dimensional view of an inductor in accordance with illustrative embodiments.

FIG. 3B depicts a two-dimensional view of a coupled inductor in accordance with illustrative embodiments.

FIG. 4A depicts a two-dimensional view of a coupled inductor in accordance with illustrative embodiments.

FIG. 4B depicts a two-dimensional view of a winding in accordance with illustrative embodiments.

FIG. 5A depicts a two-dimensional view of a cross-coupled inductor in accordance with illustrative embodiments.

FIG. 5B depicts a two-dimensional view of a cross-coupled inductor in accordance with illustrative embodiments.

FIG. 6 depicts a two-dimensional view of a cross-coupled inductor in accordance with illustrative embodiments.

FIG. 7 depicts a two-dimensional view of a cross-coupled inductor in accordance with illustrative embodiments.

FIG. 8 depicts a two-dimensional view of a cross-coupled inductor in accordance with illustrative embodiments.

FIG. 9A depicts a top perspective view of a cross-coupled inductor in accordance with illustrative embodiments.

FIG. 9B depicts a bottom perspective view of a cross-coupled inductor in accordance with illustrative embodiments.

FIG. 9C depicts a cross-sectional view of a cross-coupled inductor in accordance with illustrative embodiments.

FIG. 10 depicts a chart in accordance with illustrative embodiments.

FIG. 11 depicts a chart in accordance with illustrative embodiments.

FIG. 12 is a flowchart depicting a method in accordance with illustrative embodiments.

### DETAILED DESCRIPTION

An inductor may be used to store energy in the form of current flow (E=1/2 Li²) in a magnetic structure having by winding a conductive wire on a magnetic material (core). One or more inductors may be wound individually on the core. The illustrative embodiments recognize that power converters circuits may rely on said such inductors for performance, though converter efficiency may be limited due to large sizes and ripple currents.

The illustrative embodiments recognize that there is a need to improve converter efficiency and electromagnetic compatibility performance (EMC performance) of converters. The illustrative embodiments further recognize that with better control of each individual inductor greater converter efficiencies can be obtained and coupling inconsistencies reduced or eliminated. For example, inductor windings that are adjacent to each other may possess better coupling compared with opposite windings disposed 180 degrees away from each other. By use of a winding technique according to the illustrative embodiments, inductor coupling may be significantly improved by more even and balanced coupling between all windings. This may further result in more efficient utilization of the magnetic core and hence better overall converter efficiency.

Power converters in electric vehicles may be used to step down or step up voltages. For example, a step-up converter may boost voltages, whereas a step-down converter may lower voltages. The batteries of an electric vehicle may output several hundred volts of DC. The electric components inside the vehicle, however, may vary in their voltage requirements, as most may run on a much lower voltages. This may include includes the radio, dashboard readouts, air conditioning, microprocessors and in-built computers and displays. Step-up and step-down converters may be merged into one unit in an electric vehicle. Some electric vehicles may convert battery voltages (e.g., 180-300 volts) to around 650 volts to power a traction motor as one application of a step-up converter. A step down converter may be used to convert high battery voltages to lower voltages (12-14 volts) that may be used to charge auxiliary batteries and power light load devices. Said step-down converter may generate a series of on-off pulses and may utilize a combination of inductors and capacitors to smoothen the pulses into a consistent Direct-Current (DC) signal, whose current may be constant and whose voltage may be determined by the duty cycle (the duration of ‘on’ states relative to “off” ones).

Further, as described herein, electric vehicles may have one or more bi-directional DC-DC converters. In an example, 12V and 48V systems may be segmented in a vehicle architecture, with lower power applications linked to the 12V auxiliary battery side and higher power applications (generally those needing motors and/or heating components) attached to a 48V auxiliary battery. A bi-directional DC-DC converter may not only be used between traction and range-extender batteries but may also be used in these mixed voltage auxiliary systems, acting as a bridge between the two voltages. Thus, a step-down (‘buck’) and a step-up (‘boost’) converter may allow one battery to charge the other, allowing the use of the same external components (including passive devices like inductors and capacitors) for both step-up and step-down conversions. As a result, the vehicle's size and weight may be are lowered, increasing its efficiency and range while lowering its production costs. In an example requiring high currents, a buck converter circuit may have a power switch and a diode for chopping a dc input voltage to a rectangular waveform, responsive to which a low-pass LC filter may sieve high-frequency switching ripple and noise to obtain a DC voltage in a load terminal. This may be achieved to some extent as efficiency may be limited to due to copper losses and large ripple currents. For example, for a single-phase buck converter, high currents may lead to excessive copper losses and large ripple currents may increase output capacitor requirements when the inductor used required to be small. Further, winding a multi-phase inductor in a conventional manner may produce uneven coupling which may yield less balanced current waveforms in each inductor resulting in increased core losses which may produce less efficient power conversion. Imbalanced current flow may further result in higher EMC emissions and for high power conversion inefficiency may result in more heat which may have to be accommodated. Thus, running cooler and reducing thermal stress on electronic components may improve reliability.

The illustrative embodiments are directed to a cross-coupled multi-phase inductor and methods of use thereof. The illustrative embodiments further recognize that strong coupling may reduce ripple and balance phase currents via an optimal cross-coupled inductor topology. The cross-coupled multi-phase inductor includes a single core that enables a reduction in the size of the inductor. At least one pair of windings may be wound on the single core, the at least one pair of windings, referred to herein as adjacent windings may comprise a main winding and a coupled winding and each adjacent winding may comprise a first portion and a second portion which extends from the first portion. By placing the first and second portions of the main winding and coupled windings are on opposite sides of the single core and cross-coupling them, a coupling between the adjacent windings and resultant coupling coefficients may be strengthened and inductor phase currents may be more balanced (equal and in-phase) than is presently available, resulting in less wasted energy injection into the core with the magnetic material experiencing significantly less core losses.

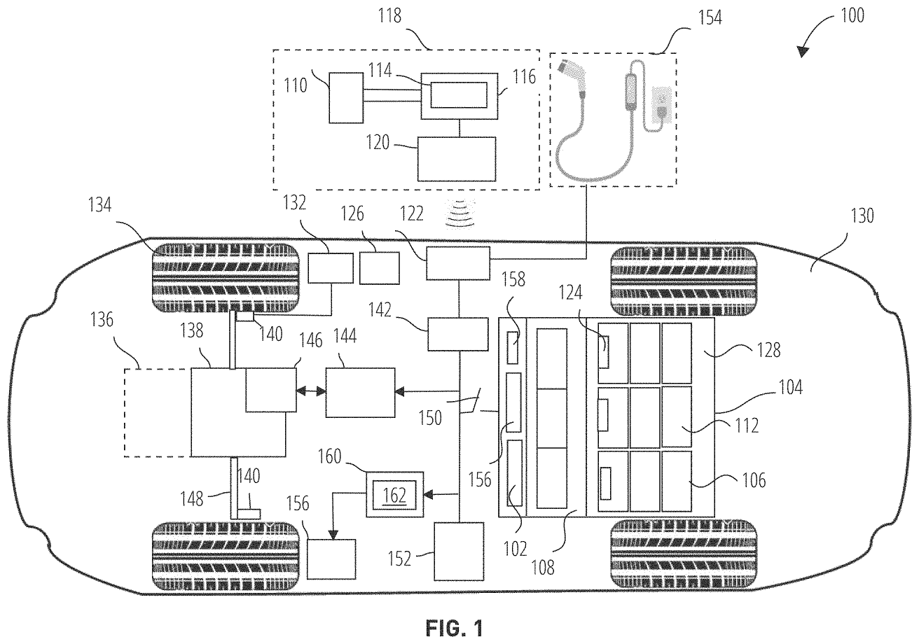

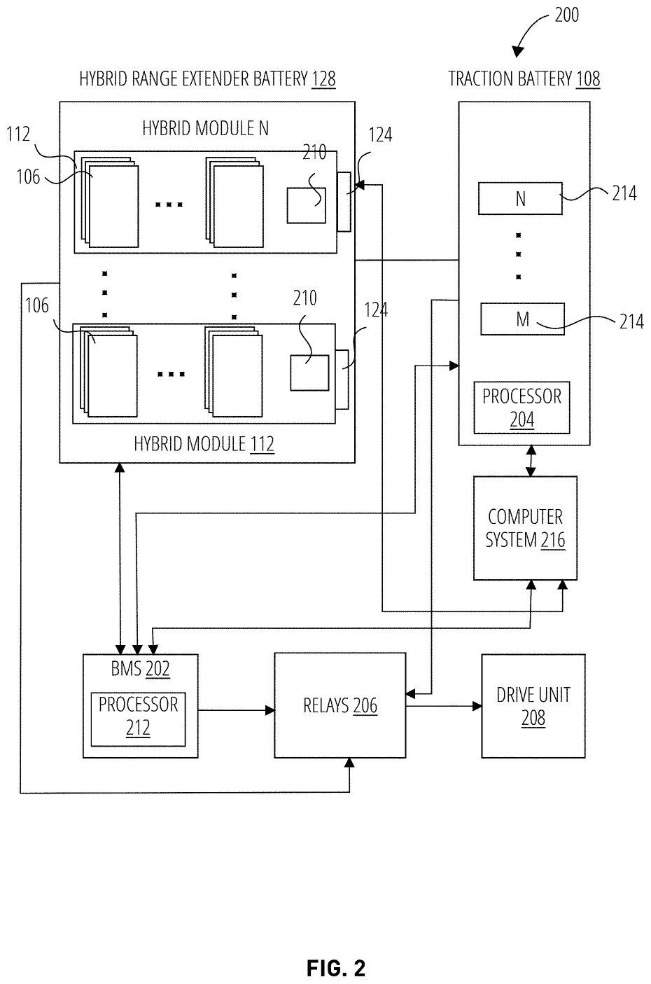

With reference to the figures and in particular with reference to FIG. 1 and FIG. 2, these figures are example diagrams of vehicle systems and power supply systems in which illustrative embodiments may be implemented. FIG. 1 and FIG. 2 are only examples and are not intended to assert or imply any limitation with regard to the environments in which different embodiments may be implemented. A particular implementation may make many modifications to the depicted environments based on the following descriptions.

FIG. 1 is a schematic of a generalized electric vehicle system 100 in which a DC-DC converter module 160 containing a power converter 162 may be housed will be described. The electric vehicle system 100 may apply to all electrified/electric vehicles, including, but not limited to, battery electric vehicles (BEV's), plug-in hybrid electric vehicles, motor vehicles, railed vehicles, watercraft, and aircraft configured to utilize rechargeable electric batteries as their main source of energy to power their drive systems propulsion or that possess an all-electric drivetrain.

The electric vehicle 130 may comprise one or more electric machines 146 mechanically connected to a transmission 138. The electric machines 146 may be capable of operating as a motor or a generator. In addition, the transmission 138 may be mechanically connected to an engine 136, as in a PHEV. The transmission 138 may also be mechanically connected to a drive shaft 148 that is mechanically connected to the wheels 132. The electric machines 146 may provide propulsion and deceleration capability when the engine 136 is turned on or off. The electric machines 146 may also act as generators and provide fuel economy benefits by recovering energy that would normally be lost as heat in the friction braking system. The electric machines 146 may also reduce vehicle emissions by allowing the engine 136 to operate at more efficient speeds and allowing the electric vehicle 130 to be operated in electric mode with the engine 136 off in the case of hybrid electric vehicles. For a BEV, the transmission 138 may be a gear box connected to an electric machine 14 and the engine 136 may not be present.

A battery pack assembly 104 may store energy that can be used by the electric machines 146. The battery pack assembly 104 may provide a high voltage DC output and may be electrically connected to one or more power electronics modules 144. In some embodiments, the battery pack assembly 104 comprises a traction battery and a range-extender battery. One or more contactors 150 may isolate the battery pack assembly 104 from other components when opened and connect the battery pack assembly 104 to other components when closed. In addition to providing energy for propulsion, the battery pack assembly 104 may provide energy for other vehicle electrical systems. The system may include a DC-DC converter module 160 configured according to methods and topologies described herein. Said module may be used to step up or step down voltages. The auxiliary DC-DC converter module 158 and/or bi-directional DC-DC converters 124 may form a part of or be separate from the DC-DC converter module 160. The auxiliary DC-DC converter module 158 may convert the high voltage DC output of the battery pack assembly 104 to a low voltage DC supply that is compatible with other vehicle loads (such as the headlights, stereo, seat heaters, ignition etc.). Other electrical loads 152, such as compressors and electric heaters, may be connected directly to the high-voltage without the use of an Auxiliary DC-DC converter module 158. The low-voltage systems such a lights and ignition system may be electrically connected to an auxiliary battery 156 (e.g., 12V battery) which may be charged via the auxiliary DC-DC converter module 158. The bi-directional DC-DC converters 124 may be used to charge the traction battery and/or charge the hybrid modules 112 of the battery pack assembly 104. In addition, the battery pack assembly 104 may have an on board AC-DC charger 102 to convert AC voltages to DC. In some embodiments, the auxiliary battery 156 may be placed within the power supply system (inside the traction battery 108) instead of outside the power supply system. Thereby, additional contactors 150 in the battery pack assembly 104 may can be controlled, for example kept closed, even if power is lost.

The battery pack assembly may also have a cell-to-pack configuration. For example, a battery pack configuration may include cells directly placed in an enclosure without the use of separate modules, with the enclosure also housing other hardware such as, but not limited to the power electronics module 144, the Auxiliary DC-DC converter module 158, the system controller 126 (such as a battery management system (BMS)), the power conversion module 142, battery thermal management system (cooling system and electric heaters) and the contactors 150. By minimizing a volume and size of the converters a consolidated arrangement with reduced heating and efficient power conversion may be provided. The power electronics module 144 may also be electrically connected to the electric machines 146 and may provide the ability to bi-directionally transfer energy between the battery pack assembly 104 and the electric machines 146. For example, a traction or range-extender battery may provide a DC voltage while the electric machines 146 may operate using a three-phase AC current. The power electronics module 144 may convert the DC voltage to a three-phase AC current for use by the electric machines 146. In a regenerative mode, the power electronics module 144 may convert the three-phase AC current from the electric machines 146 acting as generators to the DC voltage compatible with the battery pack assembly 104. The illustrative embodiments recognize that due to the numerous components that make up the drivetrain of the electric vehicle and other power supply systems, the need to supply defined amounts of voltages and currents to various systems, by reducing the sizes of inductors used in power converters and enhancing coupling between inductors may reduce imbalanced current flow and result in lower EMC emissions for high power conversion applications.

The battery pack assembly 104 may be recharged by a charging system such as a wireless vehicle charging system 118 or a plug-in charging system 154. The wireless vehicle charging system 118 may include an external power source 110. The external power source 110 may be a connection to an electrical outlet. The external power source 110 may be electrically connected to electric vehicle supply equipment 116 (EVSE). The electric vehicle supply equipment 116 may provide an EVSE controller 114 to provide circuitry and controls to regulate and manage the transfer of energy between the external power source 110 and the electric vehicle 130. The external power source 110 may provide DC or AC electric power to the electric vehicle supply equipment 116. The electric vehicle supply equipment 116 may be coupled to a transmit coil 120 for wirelessly transferring energy to a receiver 122 of the vehicle 130 (which in the case of a wireless vehicle charging system 118 is a receive coil). The receiver 122 may be electrically connected to a charger or on-board power conversion module 156. The receiver 122 may be located on an underside of the electric vehicle 130.

In the case of a plug-in charging system 154, the receiver 122 may be a plug in receiver/charge port and may be configured to charge the battery pack assembly 104 upon insertion of a plug in charger. The power conversion module 142 may condition the power supplied to the receiver 122 to provide the proper voltage and current levels to the battery pack assembly 104. The power conversion module 142 may interface with the electric vehicle supply equipment 116 to coordinate the delivery of power to the electric vehicle 130.

One or more wheel brakes 140 may be provided for decelerating the electric vehicle 130 and preventing motion of the electric vehicle 130. The wheel brakes 140 may be hydraulically actuated, electrically actuated, or some combination thereof. The wheel brakes 140 may be a part of a brake system 132. The brake system 132 may include other components to operate the wheel brakes 140. For simplicity, the figure depicts a single connection between the brake system 132 and one of the wheel brakes 140. A connection between the brake system 132 and the other wheel brakes 138 is implied. The brake system 132 may include a controller to monitor and coordinate the brake system 132. The brake system 132 may monitor the brake components and control the wheel brakes 140 for vehicle deceleration. The brake system 132 may respond to driver commands and may also operate autonomously to implement features such as stability control. The controller of the brake system 132 may implement a method of applying a requested brake force when requested by another controller or sub-function. FIG. 1 is intended as an example, and not as an architectural limitation for the different illustrative embodiments.

With reference to FIG. 2, the traction battery 108 may include one or more traction modules 214 configured to power the vehicle. The hybrid range extender battery 128 may be designed to be modular, having one or more than one type of chemistry, different from or the same as the chemistry of the traction battery 108, for the purpose of providing the vehicle with its varying power requirements when needed. The hybrid range extender battery 128 may be designed to have one or a plurality of hybrid modules 112 or packs that are configured with respective bi-directional DC-DC converters 124 to act as standalone batteries. By being able to independently control the hybrid modules 112, and independently measure the health or state of its individual cells 106, a charging and discharge rate the cells 106 can be regulated. In an embodiment, cells 106 of the hybrid modules 112 are arranged in series.

In an embodiment, each hybrid module 112 also has an operatively coupled hybrid module controller 210 for measuring the health or state of the cells 106. For example, a hybrid module controller 210 can be configured to measure the voltage, current, temperature, SOC (State of Charge), SOH (State of Health) for all cells of the corresponding hybrid module 112. It may also have a DC-DC converter control to allow isolation and current to be managed and to throttle their contribution, both absorbing and providing energy to a main bus/high voltage DC-DC bus of the power supply system 200.

The system may also have a BMS 202 configured to primarily communicate with the traction battery 108. In case a traction battery 108 malfunctions, one of more of the hybrid module 112 can act as a replacement, (e.g., temporary replacement) for the traction battery 108 by supplying power directly to the drive unit 208. One or more processors (processor 212, processor 204 or a processor of computer system 216) may be used in a number of configurations to enable the performance of one or more processes or operations described herein. Relays 206 may be controlled to operatively couple the drive unit 208 of the vehicle to power from the power supply system 200. The drive unit 208 may collectively refer to devices outside the power supply system 200 such as a propulsion motors, inverter, HVAC (Heating, Ventilation, and Air Conditioning) system, etc.

In an embodiment, the plurality of hybrid modules 112 may be connected in parallel to a main traction bus/high voltage DC bus, a plurality of traction modules 214, and a plurality of bi-directional DC-DC converters 124. In addition, it may have an on board AC-DC charger, an auxiliary battery for powering lights and ignition of the vehicle, an auxiliary DC-DC converter for connecting the auxiliary battery to the lights and ignition, contactors for switching various circuits on or off, and a control module for controlling the power supply. Moreover, by using a bi-directional DC-DC converter for each hybrid module 112, the current input and output for each hybrid module 112 can be precisely controlled unlike in load following conventional solutions which have no control over changing drive power. In an illustrative embodiment, charge and discharge pulses are generated for the hybrid modules 112. By controlling the current for the series connected cells 106 of the hybrid module 112 through a bi-directional DC-DC converter 124, and measuring the voltages of each of the cells 106, the impedances of said each of the cells 106 are computable and comparable to reference data, to identify any unwanted deviations in a cell impedance and a corresponding change in the health of the cell. FIG. 2 is intended as an example, and not as an architectural limitation for the different illustrative embodiments.

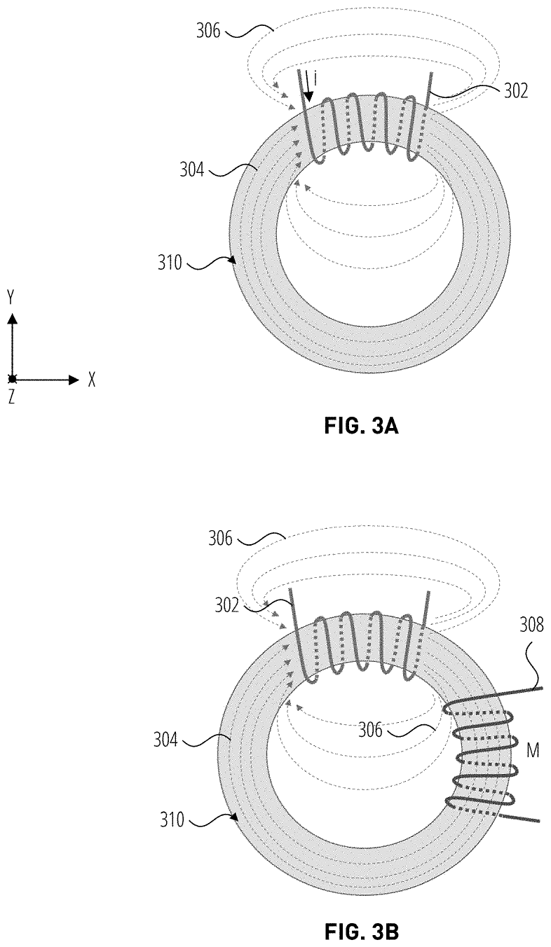

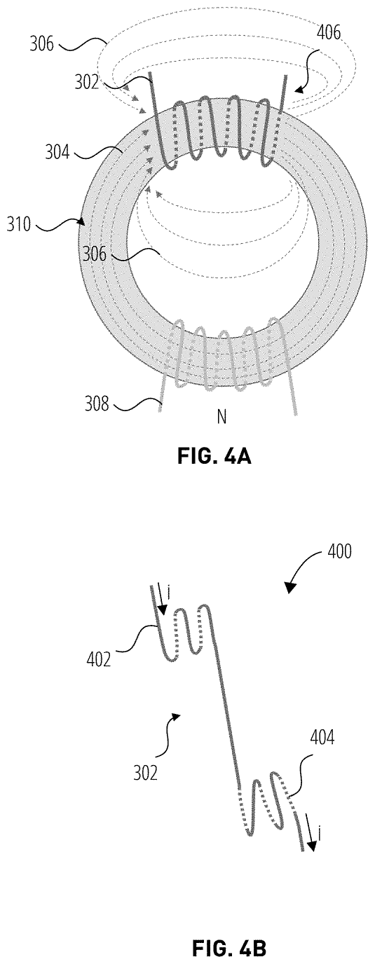

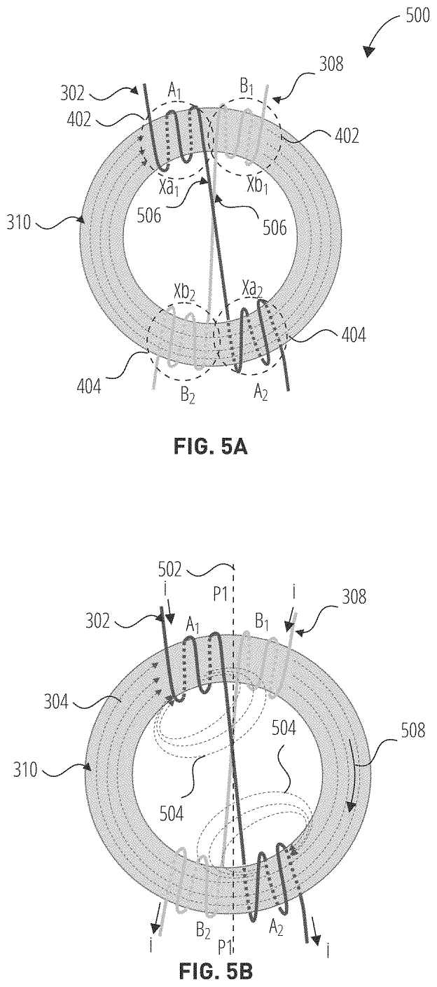

With reference to FIG. 3A—FIG. 5B, a technique for cross-coupling windings or coils 406 on a core is illustrated. FIG. 3A shows a core 310 about which a main winding 302 is wound. The core may have a toroidal shape. When current i, passes though the coil, a magnetic flux (core flux 304) may be produced in the core in a clockwise direction (looking into XY plane/into the page). In addition, a leakage flux 306 may also be produced outside the core 310 and may not be utilized for any work. Other windings may be disposed on the core 310 near the main winding and may be coupled or linked to the main winding by the core flux 304 and/or a portion of the leakage flux 306. All windings on the core may produce individual fluxes in the core that contribute to form a total mutual flux in the core. As shown in FIG. 3B and FIG. 4A, coupled windings 308 M and N maybe be respectively wound around the core. It can be seen that coupled winding M has better coupling between itself and the main winding compared to a coupling between coupled winding N and the main winding. This may be due to coupled winding M being closer to the main winding and thus receiving more of the leakage flux 306 of the main winding than coupled winding N receives. Thus, in an example having the main winding 302 and both coupled windings M and N, the coupling between pairs of windings may be uneven and imbalanced.

As shown in FIG. 4B however, the main winding 302 may be configured to have a topology of sub-windings (first sub-winding 402 and second sub-winding 404) geometrically spaced from each other, which when “cross coupled” with a similar topology of the coupled winding 308 increases the amount of leakage fluxes shared between the sub-windings and by extension between the whole winding of separate inductors 400, resulting in an increase in the coupling between said separate inductors. This may be more clearly shown by the topologies of FIG. 5A and FIG. 5B.

FIG. 5A shows a cross-coupled multi-phase inductor 500 comprising a main winding 302, and a coupled winding 308. Said main winding 302 and coupled winding 308 of the topology of FIG. 5A and similar topologies may be referred to herein as a pair of adjacent windings 506. The cross-coupled multi-phase inductor 500 further comprises a core 310, and each member of the pair of adjacent windings may have a first sub-winding 402 and a second sub-winding 404. The main winding 302 comprises a first sub-winding (A1) and a second sub-winding (A2). The coupled winding 308 also comprises a first sub-winding (B1) and a second sub-winding (B2). As shown in FIG. 5B, sub-winding leakage fluxes 504 of A1 and A2 are strongly linked/coupled with B1 and B2 respectively, more so than the windings are in FIG. 3B or FIG. 4A due to the shorter distances between neighboring windings in FIG. 5B which may allow for more leakage fluxes to be usable for work in respective magnetic circuits.

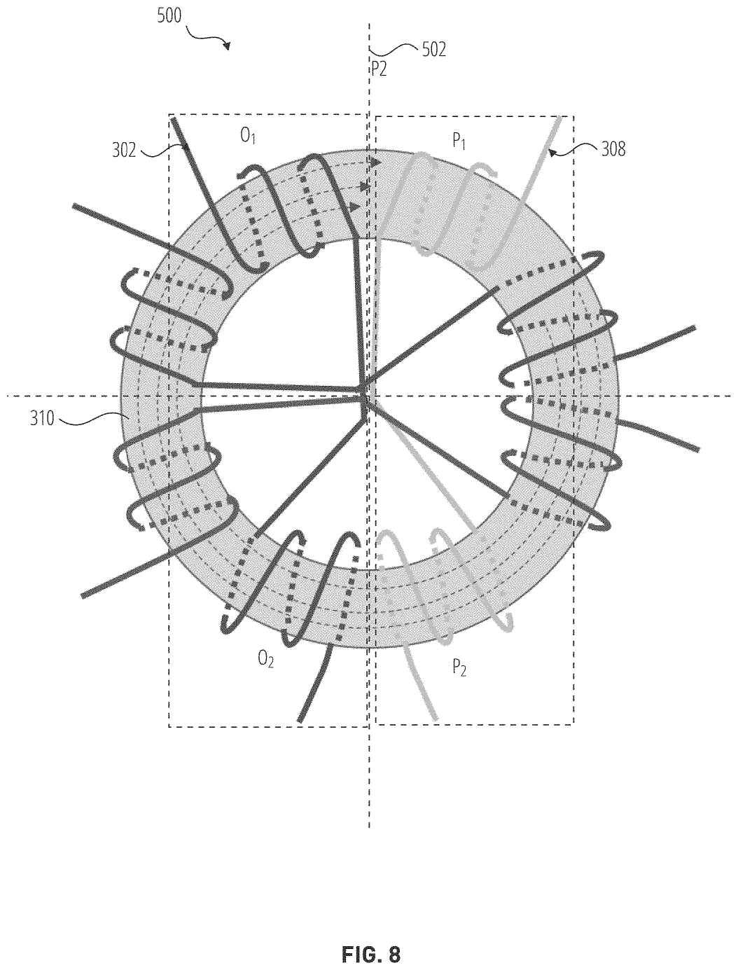

The cross-coupled multi-phase inductor 500 may however include more than one pair of adjacent windings. More specifically, the cross-coupled multi-phase inductor 500 may comprise a single core 310, and at least one pair of adjacent windings 506 wound on the single core 310. The at least one pair of adjacent windings 506 may comprise a main winding 302 and a coupled winding 308, each adjacent winding of the at least one pair further including a first sub-winding 402 and a second sub-winding 404 which extends from the first sub-winding 402. The first and second sub-windings of the main winding 302 may be disposed on first opposing sides (Xa1 and Xa2) of the single core. The first and second sub-windings of the coupled winding 308 may also be disposed on second opposing sides (Xb1 and Xb2) of the single core adjacent to said first opposing sides, with the first and second sub-windings of the main winding being cross-coupled with the first and second sub-windings of the coupled winding. In an embodiment, the core 310 is symmetric and the first opposing sides are diametrically opposite each other, i.e., a straight line drawn from one side and through the center of the core also intersects the other side. However, the first opposing sides may also be substantially opposite each other without having to be diametrically opposite (e.g., Xb2 being switched with Xa2, or as shown in FIG. 8 the opposing sides being be located on opposite ends of a diameter of a semicircle that contains the two sides).

In embodiments herein, each adjacent winding may form an inductor wherein an input signal is applied at the first sub-windings and an output signal is received at the second sub-windings. In the designing of the cross-coupled multi-phase inductor 500, wire gauge, number of turns, core cross-sectional area and magnetic path length (among other considerations) may be traded to obtain the desired goals. For example, to minimize a size of the cross-coupled multi-phase inductor 500, the sub-windings may be wound on the single core 310 such that there may be no unused space or there may be minimal unused space left on the core. Thus, a size of the cross-coupled multi-phase inductor may be reduced relative to another size of a corresponding non-cross-coupled multi-phase inductor having a same number of inductors and inductor turns. Further, in an embodiment, each of the adjacent windings may have a same number of turns and each sub-winding of all adjacent windings may have a same number of turns.

Further, as is shown in FIG. 5B, the cross-coupled multi-phase inductor may also include where the first and second sub-windings of the at least one adjacent winding are wound to produce corresponding fluxes in the single core 310 in a same direction (clockwise or anticlockwise direction). For example, the first sub-winding A1 of the main winding 302 is wound in an anticlockwise direction (from the perspective of plane 502 (P1)) such that a corresponding magnetic flux produced in the core, when A1 receives an input signal, is in the clockwise direction 508. The second sub-winding A2 of the main winding 302 is wound in an anticlockwise direction (from the perspective of plane 502 (P1)) such that when A2 receives the signal from A1, a corresponding magnetic flux produced in the core is also in the clockwise direction 508. The winding method may also be applicable to the first and second sub-windings of the coupled winding 308.

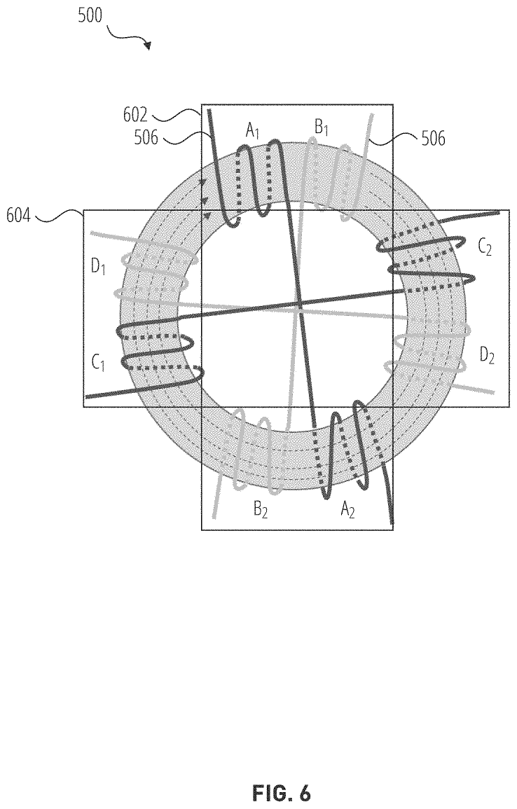

With reference to FIG. 6, a cross-coupled multi-phase inductor 500 having two pairs of adjacent windings is shown. The two pairs of adjacent windings may comprise a first pair of adjacent windings 602, and a second pair of adjacent windings 604. Thus, the cross-coupled multi-phase inductor 500 of FIG. 6 may have four inductors. In such a configuration that has more than one pair of adjacent windings no first sub-winding may be disposed adjacent to a second sub-winding of the same inductor. Thus, the sub windings may be evenly distributed around the core to increase coupling between windings and thus corresponding coupling coefficients between them which may result in balancing ramping currents in pairs of inductors in this and other embodiments as discussed hereinafter.

Further, each inductor may be linked, through its first or second sub-winding, with the sub-winding leakage fluxes 504 of the remaining inductors by a same amount or substantially the same amount due to the symmetrical arrangements described herein, i.e., for example, as shown in FIG. 6, inductor A, having first sub-winding A1 and second sub-winding A2 may be linked to neighboring inductors B and D through sub-winding leakage fluxes produced by D1, B1, D2 and B2. Likewise, inductor B, having first sub-winding B1 and second sub-winding B2 may be linked to neighboring inductors A and C through sub-winding leakage fluxes produced by A1, C2, A2 and C1. Inductor C, having first sub-winding C1 and second sub-winding C2 may be linked to inductors neighboring B and D through sub-winding leakage fluxes produced by B2, D1, B1 and D2. Likewise, inductor D, having first sub-winding D1 and second sub-winding D2 may be linked to neighboring inductors A and C through sub-winding leakage fluxes produced by C1, A1, C2, C2 and A2. By configuring the size of the core such that the sub-winding turns are distributed evenly around the core, the coupling may be improved due to a larger portion of the leakage flux of the main windings cutting through/linking with the coupled windings as the coupled windings are brought physically closer to the main windings in each sub-winding section. More specifically, when the second pair of adjacent windings 604 is added to a single core having the first pair of adjacent windings 602, said second pair of adjacent windings 604 may also be physically closer to all the other sub-winding pairs. A net result may be a more even balance of the coupling of all four windings/inductors with each other. The circuit topology may thus balance currents flowing in each winding as any imbalance from unequally coupled windings may result in more core losses.

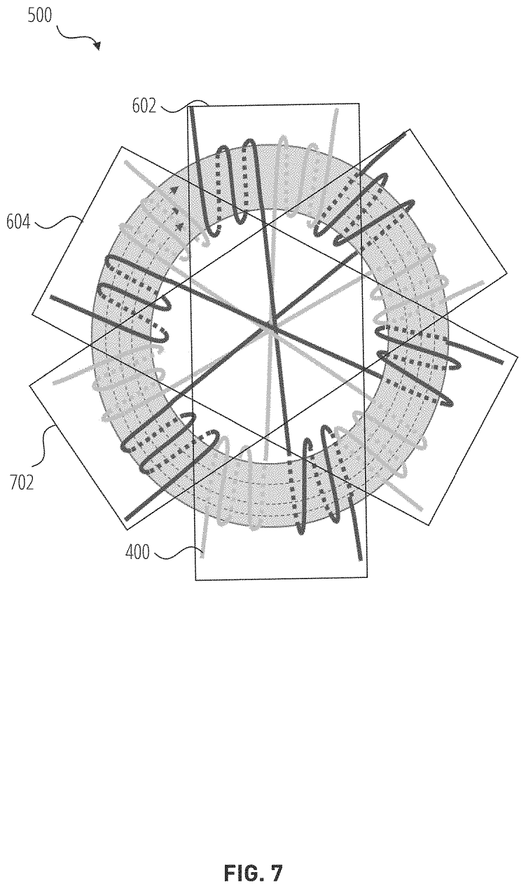

FIG. 7 illustrates another cross-coupled multi-phase inductor 500 having three pairs of adjacent windings including a first pair of adjacent windings 602, a second pair of adjacent windings 604, and a third pair of adjacent windings 702. As can be seen in this example, any even number of inductors 400 may have more evenly balanced coupling by the cross-coupling of pairs techniques described herein.

In some embodiments, due to geometric restrictions in circuit boards, the first and second sub-windings of each inductor may not be displaced exactly diametrically opposite each other as shown in FIG. 8. Instead, they may be placed substantially diametrically opposite each other as shown. In this example, the position of second sub-windings O2 and P2 are switched to, for example, enable connection of inductor coil wire end strips to defined positions on printed circuit boards. Since the sub-windings of each member of a pair of adjacent windings are not exactly diametrically opposite each other, there may be imbalances observed in the coupling arrangement. However, said imbalances may be minimized by minimizing the extent to which the locations of second sub-windings (e.g., O2 and P2) veer from plane 502 (P2). More specifically, the opposing sides may being be located on opposite ends of a diameter of a semicircle that contains the two sides.

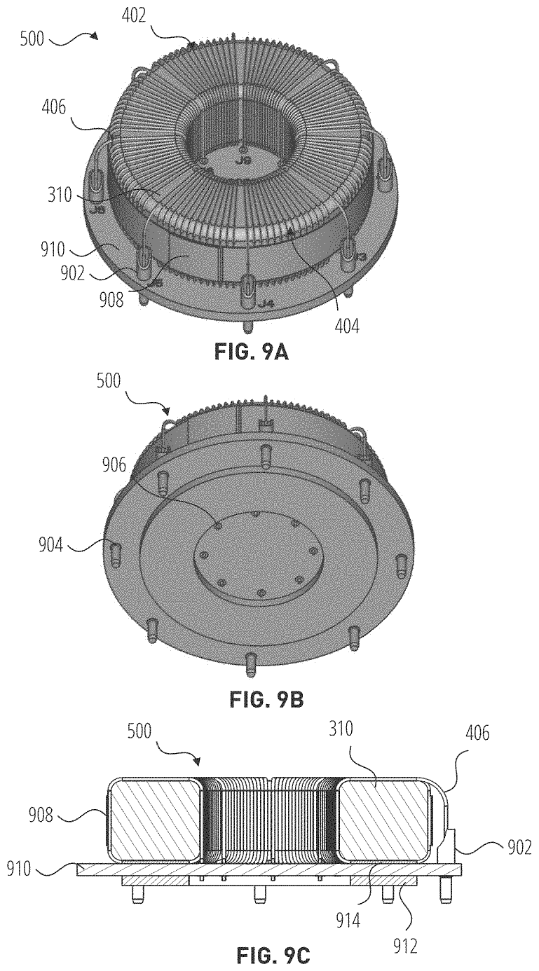

With reference to FIG. 9A and FIG. 9B, three-dimensional perspective views of a cross-coupled multi-phase inductor 500 having two pairs of adjacent windings are shown. FIG. 9C shows a cross-sectional view of the cross-coupled multi-phase inductor 500. Said cross-coupled multi-phase inductor 500 may comprise a core 310 which may be a coated magnetic core. It may also comprise windings or coils 406 that form a plurality of inductors each having a first sub-winding 402 and a second sub-winding 404 disposed diametrically opposite the first sub-winding 402. Each sub-winding may have a terminal 902 with a solder cup for soldering to one end of the sub-winding to the terminal if needed. Said terminals 902 may be pressed into unplated through-holes 904 situated in the carrier PCB 910 (printed circuit board). The turns of the windings may be held in place by a tape with contact adhesive 908. Further, the carrier PCB 910 may have plated through-holes 906 for each sub-winding wherein wires/traces on the printed circuit board may connect the first sub-windings 402 to their respective second sub-windings 404 through the plated through-holes 906. A structural adhesive 914 may be used to fasten the core 310 onto the carrier PCB 910 and a spacer with contact adhesive 912 may be disposed on an underside of the cross-coupled multi-phase inductor 500.

The cross-coupled multi-phase inductor 500 may be used in a power converter 162 of an electric vehicle 130 or power supply system, such as in the DC-DC converter module 160 or power conversion module 142 or battery pack assembly 104 of FIG. 1. In one aspect, the power converter 162 includes a plurality of inductors configured as a cross-coupled multi-phase inductor 500, the cross-coupled multi-phase inductor comprising a single core 310, and at least one pair of adjacent windings 506 wound on the single core 310, the at least one pair of adjacent windings 506 including a main winding 302 and a coupled winding 308, each adjacent winding 506 of the pair further including a first sub-winding 402 and a second sub-winding 404 which extends from the first sub-winding 402. As disclosed herein, the first and second sub-windings of the main winding may be disposed on first opposing sides of the single core, and the first and second sub-windings of the coupled winding may be disposed on second opposing sides of the single core adjacent to said first opposing sides. Since the main winding is brought near/in close proximity to the coupled winding and first and second sub-windings of each sub-winding are diametrically opposite each other, the first and second sub-windings of the main winding may be considered “cross-coupled” with the first and second sub-windings of the coupled winding by their adjacency.

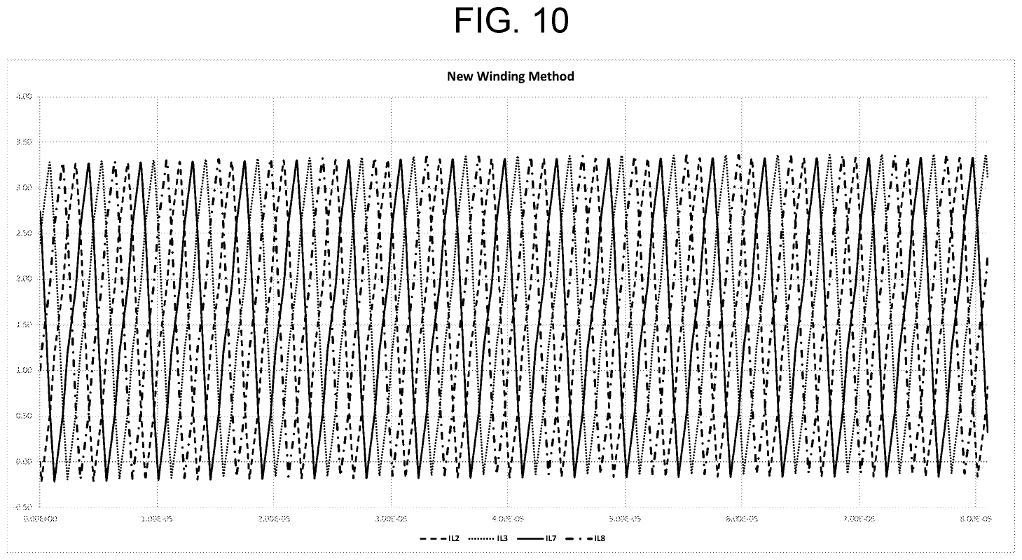

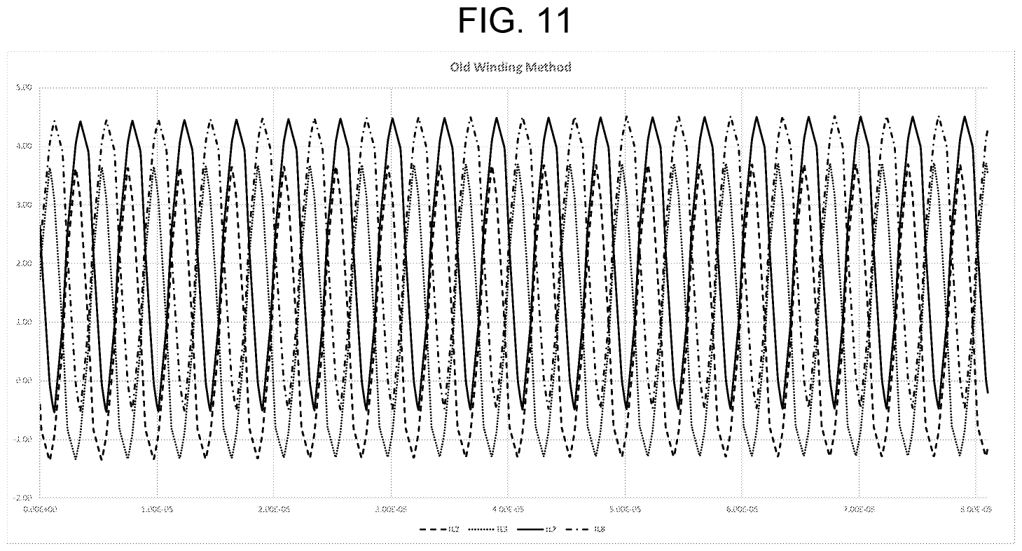

In an embodiment, the power converter may be configured as a buck/step-down converter. In a circuit of said buck converter, the circuit may have 4 inductors configured as a cross-coupled multi-phase inductor 500 and the circuit may be shifted 90° (0°, 90°, 180°, 270°). More specifically, the circuit may comprise a multi-phase buck converter and may have a phase-shifted interleaved supply that is shifted 90° apart. FIG. 10 illustrates phase currents IL1, IL2, IL3 and IL4 produced in inductors L1, L2, L3 and L4 of a cross-coupled multi-phase inductor 500 and FIG. 11 shows phase currents IL1, IL2, IL3 and IL4 produced in inductors L1, L2, L3 and L4 of a non-cross-coupled multi-phase inductor having a conventional coupling wherein with the inductor coils are wound on the same core without the cross-coupling technique described herein. The y-axis (1002) shows the current values in amperes and the x-axis (1004) shows the time in seconds. It can be seen that the peak-peak values of the phase currents in FIG. 10 are more equal and in phase compared to the phase currents of FIG. 11.

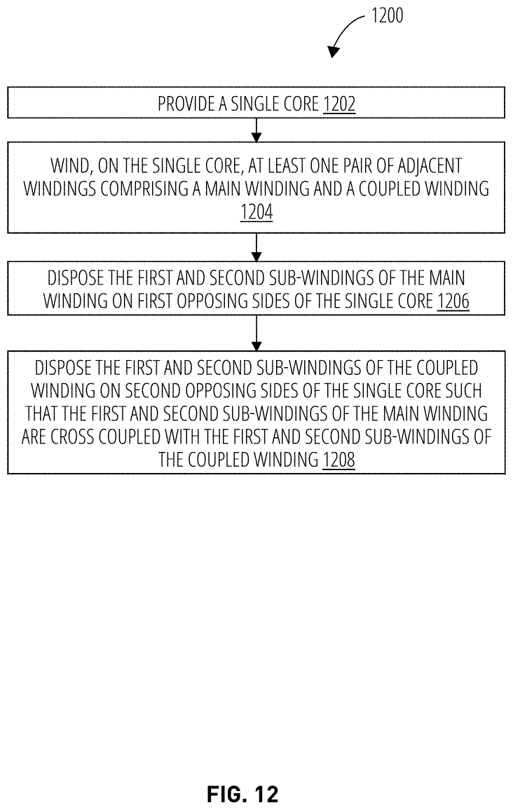

With reference to FIG. 12, a method of producing a cross-coupled multi-phase inductor 500 is shown. The method begins at step 1202, wherein a single core is provided. In step 1204, method 1200 may include winding, on the single core, at least one pair of adjacent windings, the at least one pair of adjacent windings comprising a main winding and a coupled winding. Each adjacent winding of the pair may further comprise a first sub-winding and a second sub-winding which extends from the first sub-winding. In step 1206, the first and second sub-windings of the main winding may be disposed on first opposing sides of the single core. The opposing sides may be diametrically opposite or substantially diametrically opposite. In step 1208, method 1200 disposes the first and second sub-windings of the coupled winding on second opposing sides of the single core, the second opposing sides being adjacent to the first opposing sides. The disposition may be such that the first and second sub-windings of the main winding are cross-coupled with the first and second sub-windings of the coupled winding, i.e. the diametrically opposite or substantially diametrically opposite disposition of the sub-windings of the adjacent coils may be carried out such that they form an “X” shape that evens coupling amongst the sub-windings and increases the proportion of sub-winding leakage fluxes 504 linked to the sub-windings, thus reducing core losses and increasing power conversion efficiency compared to core losses and power conversion efficiency of a corresponding non-cross coupled multi-phase inductor.

In the method 1200, the first and second sub-windings of a member of the at least one pair of adjacent winding to produce corresponding fluxes in the single core in a same direction (clockwise or anticlockwise direction around the core 310). In the method 1200, each adjacent winding may form an inductor. Further, the cross-coupling may improve a co-efficient of coupling between the main winding and the coupled winding relative to that of a corresponding non-cross-coupled main winding and coupled winding. In an embodiment, the method 1200 comprises providing the cross-coupled multi-phase inductor as a replacement for a plurality of non-cross coupled inductors in the power converter. This may result in reducing inductor ripple currents in a power converter by relative to inductor ripple currents observed on the corresponding non-cross coupled inductors. Such a power converter may be phase shifted 90° apart (0°, 90°, 180°, 270°) and the phase-shifting may be performed at defined duty cycle to reduce an inductor ripple compared to another inductor ripple of a corresponding single phase power converter.

The flowchart and block diagrams in the Figures illustrate the architecture, functionality, and operation of possible implementations of systems, methods, and devices according to various embodiments of the present invention. In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A cross-coupled multi-phase inductor comprising:
a single core; and
at least one pair of adjacent windings wound on the single core, the at least one pair of adjacent windings comprising a main winding and a coupled winding, each adjacent winding of the at least one pair of adjacent windings further comprising a first sub-winding and a second sub-winding which extends from the first sub-winding;
wherein the first and second sub-windings of the main winding are disposed on first opposing sides of the single core,
wherein the first and second sub-windings of the coupled winding are disposed on second opposing sides of the single core adjacent to said first opposing sides, and
wherein the first and second sub-windings of the main winding are cross-coupled with the first and second sub-windings of the coupled winding.

2. The cross-coupled multi-phase inductor of claim 1, wherein each adjacent winding forms an inductor.

3. The cross-coupled multi-phase inductor of claim 2, wherein cross-coupled multi-phase inductor has an even number of inductors.

4. The cross-coupled multi-phase inductor of claim 2, wherein the at least one pair of adjacent windings are two pairs of adjacent windings, and wherein the cross-coupled multi-phase inductor comprises four inductors.

5. The cross-coupled multi-phase inductor of claim 2, wherein each inductor is linked, through its first or second sub-winding, with the sub-winding leakage fluxes of the remaining inductors, by a same amount.

6. The cross-coupled multi-phase inductor of claim 2, wherein a size of the cross-coupled multi-phase inductor is reduced relative to another size of a corresponding non-cross-coupled multi-phase inductor having a same number of inductor turns.

7. The cross-coupled multi-phase inductor of claim 1, wherein the first and second sub-windings of an adjacent winding of the at least one pair of adjacent windings are wound to produce corresponding fluxes in the single core in a same direction.

8. The cross-coupled multi-phase inductor of claim 1, wherein the first opposing sides are diametrically opposite each other or substantially diametrically opposite each other and the second opposing sides are diametrically opposite each other or substantially diametrically opposite each other.

9. The cross-coupled multi-phase inductor of claim 1, wherein no first sub-winding is disposed adjacent to a second sub-winding of the same coil.

10. The cross-coupled multi-phase inductor of claim 1, wherein the single core has a toroidal shape.

11. The cross-coupled multi-phase inductor of claim 1, wherein each of the adjacent windings has a same number of turns.

12. A power converter comprising:
a plurality of inductors configured as a cross-coupled multi-phase inductor, the cross-coupled multi-phase inductor comprising:
a single core; and
at least one pair of adjacent windings wound on the single core, the at least one pair of adjacent windings comprising a main winding and a coupled winding, each adjacent winding of the pair further comprising a first sub-winding and a second sub-winding which extends from the first sub-winding;
wherein the first and second sub-windings of the main winding are disposed on first opposing sides of the single core,
wherein the first and second sub-windings of the coupled winding are disposed on second opposing sides of the single core adjacent to said first opposing sides, and
wherein the first and second sub-windings of the main winding are cross-coupled with the first and second sub-windings of the coupled winding.

13. The power converter of claim 12, wherein each adjacent winding forms an inductor.

14. The power converter of claim 12, wherein the power converter is a buck converter.

15. The power converter of claim 13, wherein the at least one pair of adjacent windings comprises two pairs of adjacent windings, and wherein the cross-coupled multi-phase inductor comprises four inductors.

16. The power converter of claim 15, wherein the power converter has a circuit that is shifted 90° (0°, 90°, 180°,270°).

17. A method comprising the steps of:
providing a single core; and
winding, on the single core, at least one pair of adjacent windings, the at least one pair of adjacent windings comprising a main winding and a coupled winding, each adjacent winding of the pair further comprising a first sub-winding and a second sub-winding which extends from the first sub-winding;
disposing the first and second sub-windings of the main winding on first opposing sides of the single core,
disposing the first and second sub-windings of the coupled winding on second opposing sides of the single core, said second opposing sides being adjacent to said first opposing sides and
producing a cross-coupled multi-phase inductor by cross-coupling the first and second sub-windings of the main winding with the first and second sub-windings of the coupled winding based on said disposing steps.

18. The method of claim 17, further comprising winding the first and second sub-windings of a member of the at least one pair of adjacent windings to produce corresponding fluxes in the single core in a same direction.

19. The method of claim 17, wherein each adjacent winding forms an inductor.

20. The method of claim 19, wherein phase currents in each inductor of a power converter circuit formed by the cross-coupled multi-phase inductor are balanced resulting in reduced core losses and more efficient power conversion relative to core losses and power conversion efficiency of a corresponding non-cross coupled multi-phase inductor.

21. The method of claim 19, further comprising:
reducing inductor ripple currents in a power converter by providing the cross-coupled multi-phase inductor as a replacement for a plurality of non-cross coupled inductors in the power converter, the reducing being relative to inductor ripple currents observed on the corresponding non-cross coupled inductors.

22. The method of claim 19, further comprising:
phase shifting a power converter having the cross-coupled multi-phase inductor 90° apart (0°, 90°, 180°,270°).

23. The method of claim 17, wherein said cross-coupling improves a co-efficient of coupling between the main winding and the coupled winding relative to that of a corresponding non-cross-coupled main winding and coupled winding.

24. The method of claim 22, wherein said phase shifting is performed at defined duty cycle to reduce an inductor ripple compared to another inductor ripple of a corresponding single phase power converter.

25. The method of claim 22, wherein said phase shifting is performed at defined duty cycle to reduce an inductor ripple compared to another inductor ripple of a conventionally wound multi-phase power converter.
